(19) United States
(12) Patent Application Publication
(10) Pub. No.: US 2003/0048465 A1
(43) Pub. Date: Mar. 13, 2003

(54) Color image filing system, color image recording method, and color image recording medium

(75) Inventor: Hideyasu Ishibashi, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/236,946

(22) Filed: Sep. 9, 2002

(30) Foreign Application Priority Data
Sep. 7, 2001 (JP) 2001-271618

(51) Int. Cl. B41J 1/00; G06F 15/00

(52) U.S. Cl. 358/1.9; 358/1.15

(57) ABSTRACT

The color image recording medium for recording and preserving a color image as a hard copy includes a transmission type image recording material for recording the color image and a reflective observation diffuser detachable to the transmission type image recording material. The color image is observed through reflected light by fitting the reflective observation diffuser to an under side of the transmission type image recording material, and the color image is read through transmission light from the transmission type image recording material by removing the reflective observation diffuser from the under side of the transmission type image recording material. The color image recording method compresses a density range of image signals of a reproduced image of a color image by approximately half and records the color image on a transmission type image recording material with the compressed density range. The color image filing system includes a printer, a scanner, a computer and further, the color image recording medium.

### BACKGROUND OF THE INVENTION

The present invention relates to a color image filing system, a color image recording method, and a color image recording medium for recording and storing a color image as a hard copy and appreciating the color image as well as reproducing the color image as image data.

Recently, print systems for digitally outputting an image obtained by photographing as a very fine hard copy and scanner systems for inputting image data to the print systems have been commercially available.

There is conceivable a conventional image filing system as shown in FIG. 3 in which hard copies, and an input/output system as described above and a computer are combined.

That is, the conventional image filing system 100 shown in FIG. 3 is composed of a printer 102, a scanner 104 and a computer 106, and hard copies 108 and a permanent image file 110. The hard copies 108 output by the printer 102 are preserved by being filed as the permanent image file 110 such as an album.

Thereafter, when an image is reproduced, the hard copy 108 is read with the scanner 104, and resultant image data is input into the computer 106. The computer 106 subjects the image data to predetermined image processing and outputs the image data having been processed to the printer 102, and a reproduced image is output from the printer 102 as a hard copy.

Note that what is filed and preserved as the permanent image file 110 is not limited to a so-called print, and films such as a color negative film and color reversal film also may be filed and preserved as the permanent image file 110. When these films are preserved together with prints and images are appreciated, the prints may be observed, and when the images thereof are reproduced, they may be read with the scanner 104.

As described above, the color negative film, the color reversal film, a color paper, and the like are contemplated as an image recording medium used in the conventional image filing system.

In the conventional image filing system as described above, there are four requirements to a hard copy image (image recording medium) for the permanent image file: (1) high recording density, (2) easiness for human observation, (3) high quality information readability (easiness when an image is read with a machine, and a high degree of S/N), and (4) good preservation quality. However, since the above color negative film, color reversal film, and color paper have good points and bad points, respectively as to these requirements, a problem is arisen in that these image recording mediums cannot be used as they are for the above application without difficulty.

That is, the color negative film has a problem as to the above item (2) easiness for human observation because it records a reverse image and a special illumination unit is necessary to observe the reverse image. To observe an image recorded on the color reversal film, a special illumination unit is also necessary, from which a problem is arisen as to the above item (2) easiness for human observation.

Further, the color paper is excellent in easiness for human observation. However, when an image recorded on it is read with the scanner, it is somewhat blurred and noise is liable to be caused, and further the color paper has a problem in the above item (3) high quality information readability.

Note that when both the color paper and the color negative film are preserved, they have a problem in the item (4) good preservation quality.

### SUMMARY OF THE INVENTION

A primary object of the present invention, which was made in view of the above conventional problems, is to provide a color image filing system capable of recording and preserving a hard copy image that satisfies requirements requested thereto, in particular, high recording density, easiness for human observation, and high quality information readability.

Another object of the present invention is to provide a color image recording method used in the color image filing system described above.

Still another object of the present invention is to provide a color image recording medium used in the color image filing system described above.

The invention provides a color image recording medium for recording and preserving a color image as a hard copy, comprising: a transmission type image recording material for recording the color image; and a reflective observation diffuser detachable to the transmission type image recording material, wherein the color image is observed through reflected light by fitting the reflective observation diffuser to an under side of the transmission type image recording material, and the color image is read through transmission light from the transmission type image recording material by removing the reflective observation diffuser from the under side of the transmission type image recording material.

It is preferable that the transmission type image recording material and the reflective observation diffuser are only partly bonded to each other.

It is also preferable that the color image is recorded on the transmission type image recording material by compressing a density range of image signals of a reproduced image of said color image. More preferably, the density range of the image signals is compressed so as to reduce density values by approximately half.

The transmission type image recording material is for example a positive lightsensitive material.

The invention also provides a color image recording method, comprising the steps of: compressing a density range of image signals of a reproduced image of a color image by approximately half; and recording the color image on a transmission type image recording material with the compressed density range.

The transmission type image recording material is for example a positive lightsensitive material.

The invention also provides a color image filing system, comprising: a printer; a scanner; a computer; and further, a color image recording medium for recording and preserving a color image as a hard copy used as a medium for recording and preserving the color image, comprising: a transmission type image recording material for recording the color image; and a reflective observation diffuser detachable to the transmission type image recording material, wherein the color image is observed through reflected light by fitting the reflective observation diffuser to a lower side of the transmission type image recording material, and the color image is read through transmission light from the transmission type image recording material by removing the reflective observation diffuser from the lower side of the transmission type image recording material.

It is preferable that the color image is recorded on the transmission type image recording material by compressing a density range of image signals of a reproduced image of the color image. More preferably, the density range of the image signals is compressed so as to reduce density values by approximately half.

It is also preferable that the color image is recorded on the color image recording medium by a color image recording method comprising the steps of: compressing a density range of image signals of a reproduced image of the color image by approximately half; and recording the color image on the transmission type image recording material with the compressed density range.

More preferably, the color image is read from the color image recording medium and reproduced by performing an arithmetic operation that is in an approximately inverse functional relationship to the functional relationship when the color image is recorded.

It is also preferable that the color image is read from the color image recording medium and reproduced by performing an arithmetic operation that is in an approximately inverse functional relationship to the functional relationship when the color image is recorded.

It is still also preferable that the transmission type image recording material and the reflective observation diffuser are only partly bonded to each other.

The transmission type image recording material is for example a positive lightsensitive material.

### BRIEF DESCRIPTION OF THE DRAWINGS

FIG. 1 is a block diagram schematically showing an embodiment of a color image filing system according to the present invention;

FIGS. 2A to 2C are views explaining an embodiment of a color image recording medium (file image) according to the present invention, wherein FIG. 2A is a perspective view of the color image recording medium and FIGS. 2B and 2C are side elevational views thereof; and

FIG. 3 is a view explaining a conventional image filing system.

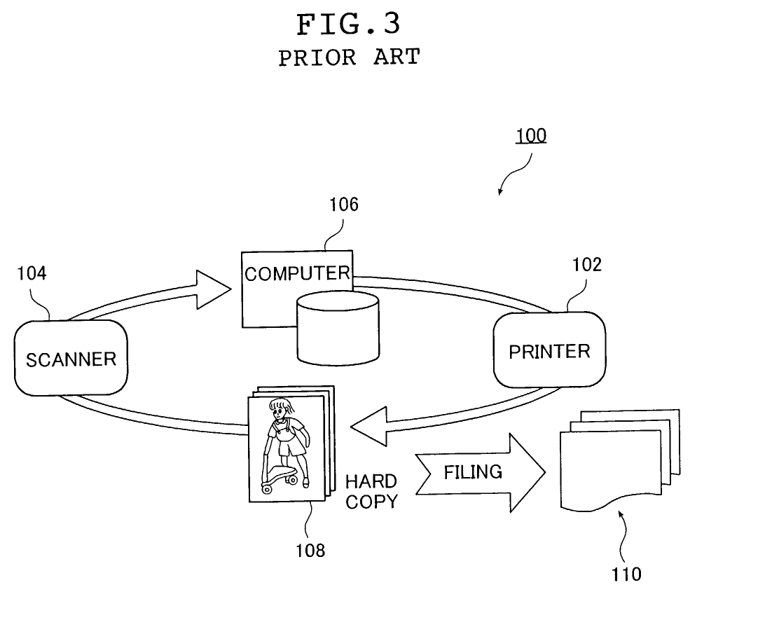

### DETAILED DESCRIPTION OF THE INVENTION

A color image filing system, a color image recording method, and a color image recording medium of the present invention will be explained below in detail with reference to a preferable embodiment shown in the accompanying drawings.

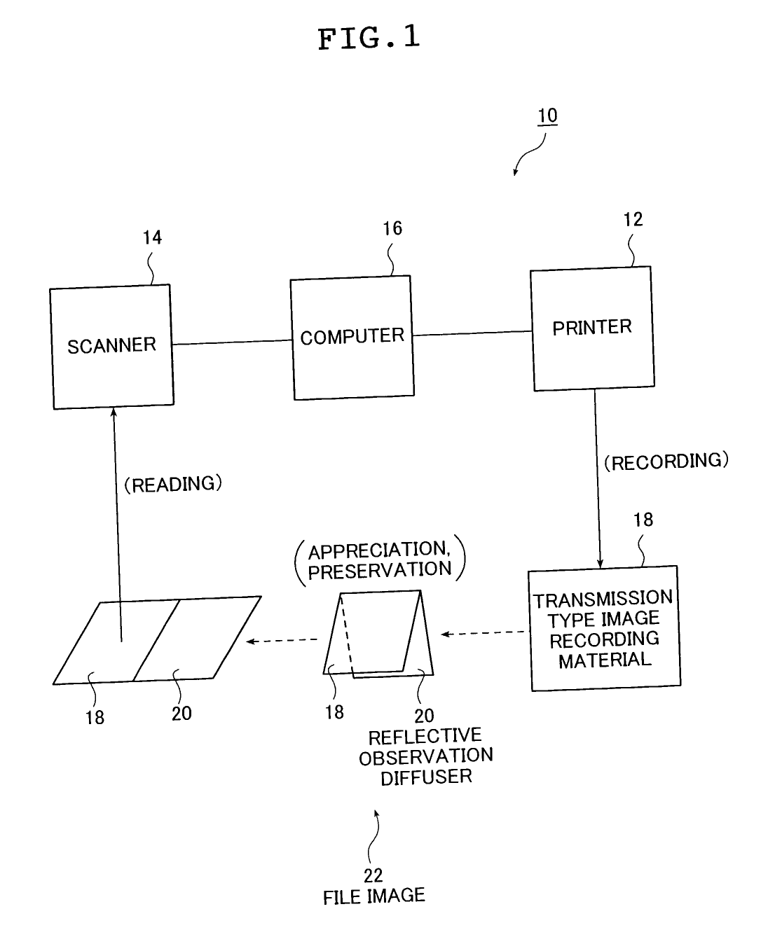

FIG. 1 schematically shows a preferable embodiment of a color image filing system according to the present invention.

As shown in FIG. 1, the color image filing system 10 is mainly composed of a printer 12 acting as a very fine color image recording unit, a scanner 14 acting as a color image reading (input) unit and a computer 16 for performing various types of image processing and controlling the system in its entirety, and a color image recording medium 22 comprising a transmission type image recording material 18 and a reflective observation diffuser 20.

The color image recording medium (file image) 22 composed of the transmission type image recording material 18 and the reflective observation diffuser 20 records and preserves a color image. It is preferable that the transmission type image recording material 18 is a positive light sensitive material so that a color image is recorded as a positive in consideration of easiness for human observation. The color image is recorded to and read from the transmission type image recording material 18.

Further, the color image is observed through reflected light by fitting the reflective observation diffuser 20 to the lower side (back side) of the transmission type image recording material 18.

The reflective observation diffuser 20 is not particularly limited and any white sheet-like member as exemplified by an unexposed color paper (CLP) having been developed may be used.

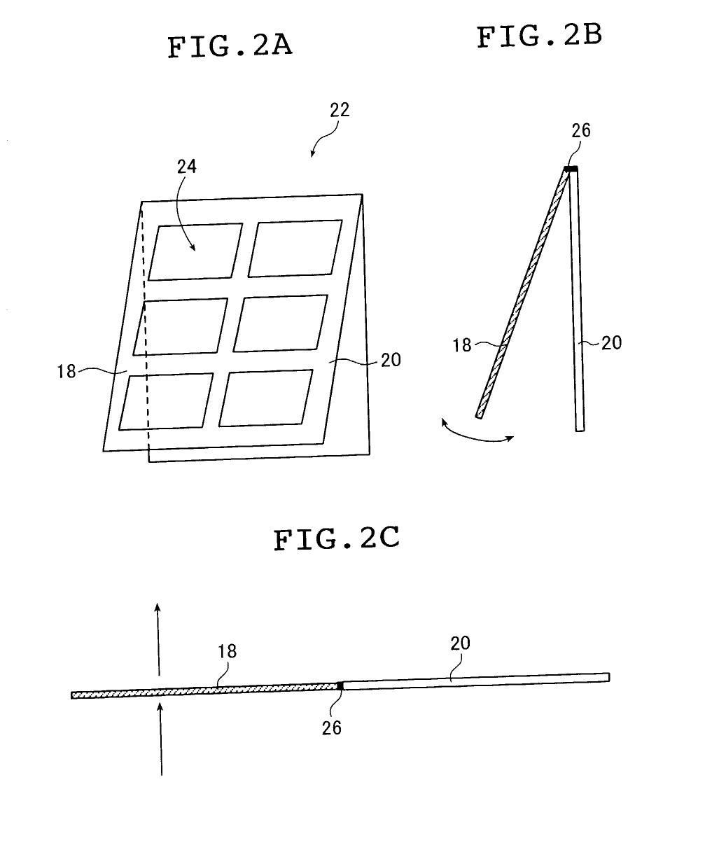

FIGS. 2A to 2C show the color image recording medium (file image) 22. FIG. 2A is a perspective view of the color image recording medium (file image) 22, and FIGS. 2B and 2C are side elevational views thereof.

As shown in FIG. 2A, the color image recording medium 22 is composed of the transmission type image recording material 18 and the reflective observation diffuser 20, and several color images 24 are recorded on the transmission type image recording material 18. Then, the color images 24 can be observed through reflected light by fitting the reflective observation diffuser 20 on the back surface of the transmission type image recording material 18.

As shown in FIG. 2B, parts of the transmission type image recording material 18 and the reflective observation diffuser 20, for example, the upper end sides 26 of both are bonded to each other so that the transmission type image recording material 18 can be turned about the bonded upper end sides 26 as shown by an arrow in FIG. 2B.

Further, when an image is read from the transmission type image recording material 18, the reflective observation diffuser 20 is turned about the bonded sides 26 and removed from the back surface of the transmission type image recording material 18 as shown in FIG. 2C and light having impinged on the back surface of the transmission type image recording material 18 and passed therethrough is read with the scanner 14.

Note that when an image is recorded on the transmission type image recording material 18, the image may be recorded by setting only the transmission type image recording material 18 to the printer 12, and the transmission type image recording material 18 and the reflective observation diffuser 20 may be bonded detachably after the image has been recorded. Otherwise, the image may be recorded by removing the reflective observation diffuser 20 as shown in FIG. 2C as in image reading.

Operation of the embodiment will be described below.

When images are recorded on the color image recording medium 22 (transmission type image recording material 18), first, an exposure control three-dimensional look-up table (3D-LUT) is created to prepare an image drawing unit.

That is, the printer 12 exposes the transmission type image recording material 18 for a 3D-LUT creating chart. The chart is developed and then scanned by the scanner 14, and a 3D-LUT showing a relationship between the logarithmic amount of exposure and the density in the printer 12 is created.

Next, the printer 12 records an image which is desired to be filed on the transmission type image recording material 18 with a high resolution as a positive image. A color image recorded on a negative film (color negative image), a color image recorded by a digital still camera (DSC image), and the like are contemplated as an image source of the color image to be recorded.

When the (color) image is recorded, an image density range is compressed to make the density of the (color) image approximately half the density of the image that seems preferable when the (color) image is observed (reproduced).

Accordingly, a recording dynamic range used can be approximately doubled. As described above, since the image is recorded with the density thereof halved, the image can be observed later through reflected light by fitting the reflective observation diffuser 20 on the back surface of the transmission type image recording material 18 on which the image is recorded. Note that when the image is recorded, matrix processing, and the like may be performed as necessary.

The reflective observation diffuser 20 is partly bonded to the transmission type image recording material 18 onto which the image has been recorded so that the former can be removed from the latter as necessary (can be of a detachable type), and they are used for the permanent file image (color image recording medium) 22.

As described above, the transmission type image recording material 18 is preserved in the state in which the reflective observation diffuser 20 is partly bonded thereto. The recorded images are observed through reflected light by fitting the reflective observation diffuser 20 on the back surface of the transmission type image recording material 18.

When the recorded images are observed as described above and an image to be reproduced is determined, the image is read from the transmission type image recording material 18 with the scanner 14 after separating the reflective observation diffuser 20 of the file image 22 from the back surface of the transmission type image recording material 18.

The captured value of the image obtained by scanning with the scanner 14 is converted into the density of the image by the computer 16. Then, an arithmetic operation (inverse arithmetic operation), which is in an approximately inverse functional relationship with respect to the functional relationship between the density of an output image and the file image when the image is recorded as described above, is performed, and a color image is reproduced on a color paper from the printer 12 based on a resultant density. Accordingly, the density is approximately doubled in this case.

Further, a conversion table for making conversion between the density of the output value from the color paper and the density of the output value from the scanner, which is necessary to the above job, is previously prepared.

While the color image filing system, the color image recording method, and the color image recording medium of the present invention have been described above in detail, the present invention is by no means limited to the above embodiment and it is needless to say that various improvements and modifications can be made within the range which does not depart from the gist of the present invention.

As described above, according to the present invention, when a filed image is observed, an image near to a reproduced image can be observed. Further, since the image density is reduced by approximately half, the recording dynamic range used in filing can be doubled. Furthermore, when an image is reproduced, the image is read making use of the transmission type optical system, whereby a reproduced image of high quality can be obtained. As a result, it is possible to record and preserve a hard copy image having a high recording density, easiness for human observation, and high quality information readability.

Next, a specific example will be explained.

### EXAMPLE

A color laser printer Model PHISUL2 made by Fuji Photo Film Co., Ltd. was used as the printer 12 to expose a sheet of “Fujichrome PROVIA 100F Professional” (made by Fuji Photo Film Co., Ltd.) used as the transmission type image recording material 18 for a 3D-LUT creating chart. The chart was developed and then scanned with a scanner Model SG1000 made by Dainippon Screen Mfg. Co., Ltd. used as the scanner 14, and the 3D-LUT showing a relationship between the amount of light and the density in the laser printer was created.

Next, portraits whose source images were derived from color negative images or DSC images were recorded on the Fujichrome PROVIA 100F Professional using the same laser printer with a high resolution of about 2000 dpi as images that were desired to be filed. A recording size was such that six images were disposed in two columns longitudinally and in three rows laterally as shown in FIG. 2A. Further, an image recording density was approximately half the image density that seems preferable in observation (reproduction).

An unexposed color paper was developed to obtain a white reflection support member having a high lightness, which was used as the reflective observation diffuser 20. The support member was partly bonded to the Fujichrome PROVIA 100F Professional having images recorded thereon so that the former can be removed from the latter as necessary. The Fujichrome PROVIA 100F Professional combined with the support member was used as the file image 22.

An image to be reproduced was determined by observing through reflected light the file image 22 to which the reflective observation diffuser 20 was fitted. When the image was reproduced, the reflective observation diffuser 20 was separated from the file image 22. Then, the image was read with a scanner Model CELSIS6250 (made by Fuji Photo Film Co., Ltd.) with a resolution of 4000 dpi, and a scanned value was converted into an image density. Then, an inverse arithmetic operation of a functional relationship between the density of an image when the image was output to the Fujichrome PROVIA 100F Professional by the laser printer (Model PHISUL2) with a resolution of about 2000 dpi and a file image, and a resultant density was reproduced on a color paper by the above laser printer. Note that a conversion table for making conversion between the density of the output value from the color paper and the density of the output value from the scanner Model CELSIS6250, which was necessary to the above job, was previously prepared.

As described above, according to the embodiment, when a filed image is observed, an image near to a reproduced image can be observed. Since the image density is reduced by approximately half, the recording dynamic range used in filing can be doubled. Further, since the transmission type optical system can be used when an image is read for image reproduction, a reproduced image of high quality can be obtained.

Actually, the result of the above specific example shows that the S/N ratio (sharpness and graininess) of the reproduced image is apparently different from that of an image output to a reflective recording material.

The example described above clearly shows the effectiveness of the present invention.

What is claimed is:

1. A color image recording medium for recording and preserving a color image as a hard copy, comprising:
a transmission type image recording material for recording the color image; and
a reflective observation diffuser detachable to the transmission type image recording material,
wherein the color image is observed through reflected light by fitting the reflective observation diffuser to an under side of the transmission type image recording material, and the color image is read through transmission light from the transmission type image recording material by removing the reflective observation diffuser from the under side of the transmission type image recording material.

2. The color image recording medium according to claim 1, wherein the transmission type image recording material and the reflective observation diffuser are only partly bonded to each other.

3. The color image recording medium according to claim 1, wherein the color image is recorded on the transmission type image recording material by compressing a density range of image signals of a reproduced image of said color image.

4. The color image recording medium according to claim 3, wherein the density range of the image signals is compressed so as to reduce density values by approximately half.

5. The color image recording medium according to claim 1, wherein the transmission type image recording material is a positive lightsensitive material.

6. A color image recording method, comprising the steps of:
compressing a density range of image signals of a reproduced image of a color image by approximately half; and
recording the color image on a transmission type image recording material with the compressed density range.

7. The color image recording method according to claim 6, wherein the transmission type image recording material is a positive lightsensitive material.

8. A color image filing system, comprising:
a printer;
a scanner;
a computer; and further,
a color image recording medium for recording and preserving a color image as a hard copy used as a medium for recording and preserving the color image, comprising:
a transmission type image recording material for recording the color image; and
a reflective observation diffuser detachable to the transmission type image recording material,
wherein the color image is observed through reflected light by fitting the reflective observation diffuser to a lower side of the transmission type image recording material, and the color image is read through transmission light from the transmission type image recording material by removing the reflective observation diffuser from the lower side of the transmission type image recording material.

9. The color image filing system according to claim 8, wherein the color image is recorded on the transmission type image recording material by compressing a density range of image signals of a reproduced image of said color image.

10. The color image filing system according to claim 9, wherein the density range of the image signals is compressed so as to reduce density values by approximately half.

11. The color image filing system according to claim 8, wherein the color image is recorded on the color image recording medium by a color image recording method comprising the steps of:
compressing a density range of image signals of a reproduced image of the color image by approximately half; and
recording the color image on the transmission type image recording material with the compressed density range.

12. The color image filing system according to claim 11, wherein the color image is read from the color image recording medium and reproduced by performing an arithmetic operation that is in an approximately inverse functional relationship to the functional relationship when the color image is recorded.

13. The color image filing system according to claim 8, wherein the color image is read from the color image recording medium and reproduced by performing an arithmetic operation that is in an approximately inverse functional relationship to the functional relationship when the color image is recorded.

14. The color image filing system according to claim 8, wherein the transmission type image recording material and the reflective observation diffuser are only partly bonded to each other.

15. The color image filing system according to claim 8, wherein the transmission type image recording material is a positive lightsensitive material.
